(19) United States
(12) Patent Application Publication
(10) Pub. No.: US 2026/0124725 A1
(43) Pub. Date: May 7, 2026

(54) POWER TOOL INCLUDING MOTOR POWER RAMPING DURING IMPACTING

(71) Applicant: MILWAUKEE ELECTRIC TOOL CORPORATION, Brookfield, WI (US)

(72) Inventors: Alejandro M. Damonte Vegas, Menomonee Falls, WI (US); Jacob R. Seifert, Lake Mills, WI (US)

(21) Appl. No.: 19/377,617

(22) Filed: Nov. 3, 2025

Related U.S. Application Data
(60) Provisional application No. 63/716,982, filed on Nov. 6, 2024.

(51) Int. Cl. B25B 23/147

(52) U.S. Cl. CPC B25B 23/1475

(57) ABSTRACT

A power tool may include a housing, a trigger, a motor, an impact mechanism and an electronic processor configured to detect a trigger pull and control the motor at a first motor power in response to the trigger pull, detect a first impact of the impact mechanism and store a count of the impact of the impact mechanism. The power tool may include control the motor at a second motor power in response to the impact of the impact mechanism, detect a second impact of the impact mechanism and increment the count of the impact; and compare the count of the impact to an impact threshold, control the motor at a third motor power in response to the count of the impact being less than the impact threshold, and stop the motor in response to the count of the impact being greater than or equal to the impact threshold.

### RELATED APPLICATIONS

This application claims the benefit of U.S. Provisional Ser. No. 63/716,982, filed Nov. 6, 2024, the entire content of which is hereby incorporated by reference.

### FIELD

This application relates to impact power tools.

### SUMMARY

Impact tools described herein include a housing, a trigger, a motor within the housing, the motor including a rotor and a stator, the rotor coupled to a motor shaft, and an impact mechanism including a hammer coupled to the motor shaft and an anvil configured to receive impacts from the hammer. The tool includes an output drive device coupled to the anvil and configured to rotate, and an electronic controller including a memory and an electronic processor. The electronic controller is configured to detect a pull of the trigger, control the motor at a first motor power in response to the pull of the trigger, detect a first impact of the impact mechanism, store a count of the impact of the impact mechanism in the memory, control the motor at a second motor power in response to the impact of the impact mechanism, detect a second impact of the impact mechanism, increment the count of the impact, compare the count of the impact to an impact threshold, control the motor at a third motor power in response to the count of the impact being less than the impact threshold, the third motor power being greater than the second motor power, and stop the motor in response to the count of the impact being greater than or equal to the impact threshold.

In some aspects, the first motor power is a maximum motor power, and the second motor power is a minimum motor power.

In some aspects, at least one of the first motor power, the second motor power and the third motor power are determined by the electronic processor using at least one selected from the group consisting of a pulse-width modulation value, a revolutions per minute setpoint, a motor conduction angle, and a motor phase angle.

In some aspects, the electronic controller is configured to control the motor at the second motor power by lowering a pulse-width modulation signal duty cycle.

In some aspects, wherein the electronic controller is configured to control the motor at the second motor power using one or more closed-loop speed control target set points.

In some aspects, the electronic processor is further configured to control the motor at the third motor power in response to the count of the impact being an even number.

In some aspects, the third motor power is greater than the second motor power by a predetermined value.

In some aspects, the third motor power is calculated by the electronic processor using an algorithm.

In some aspects, the algorithm includes at least one selected from the group consisting of a total number of impacts detected by the electronic processor, a current measurement of the motor, a voltage measurement of the motor, a revolutions per minute value of the motor, and a run time of the motor.

Methods described herein relate to controlling an impact tool including a housing, a trigger, a motor within the housing, an impact mechanism including a hammer and an anvil configured to receive impacts from the hammer, and an electronic controller including a memory and an electronic processor. The method includes detecting, using the electronic processor, a pull of the trigger, controlling, using the electronic processor, the motor at a first motor power in response to the pull of the trigger, detecting, using the electronic processor, a first impact of the impact mechanism, and storing, in the memory, a count of the impact of the impact mechanism. The method includes controlling, using the electronic processor, the motor at a second motor power in response to the impact of the impact mechanism, detecting, using the electronic processor, a second impact of the impact mechanism, incrementing, using the electronic processor, the count of the impact, and comparing, using the electronic processor, the count of the impact to an impact threshold. The method includes controlling, using the electronic processor, the motor at a third motor power in response to the count of the impact being less than the impact threshold, the third motor power being greater than the second motor power, and stopping, using the electronic processor, the motor in response to the count of the impact being greater than or equal to the impact threshold.

In some aspects, at least one of the first motor power, the second motor power and the third motor power are determined by the electronic processor using at least one selected from the group consisting of a pulse-width modulation value, a revolutions per minute setpoint, a motor conduction angle, and a motor phase angle.

In some aspects, the method further includes detecting, using the electronic processor, an impact timing of the impact mechanism, determining, using the electronic processor, whether the impact timing of the impact mechanism is within a predetermined range, and reducing, using the electronic processor, the power provided to the motor in response to the impact timing of the impact mechanism being outside of the predetermined range.

In some aspects, the method further includes calculating, using the electronic processor, a motor power value for the third motor power, increasing, using the electronic processor, the motor power value in response incrementing the count of the impact, and controlling, using the electronic processor, the motor at a third motor power.

In some aspects, the electronic processor increases the motor power value by a predetermined amount in response to every two increments of the count of the impact.

Impact tool described herein include a housing, a trigger, a motor within the housing, the motor including a rotor and a stator, the rotor is coupled to a motor shaft, and an impact mechanism including a hammer coupled to the motor shaft and an anvil configured to receive impacts from the hammer. The tool includes an output drive device coupled to the anvil and configured to rotate, and an electronic controller including a memory and an electronic processor. The electronic controller is configured to detect a pull of the trigger, control the motor at a maximum motor power in response to the pull of the trigger, detect a first impact of the impact mechanism, store a count of the impact of the impact mechanism in the memory, control the motor at a minimum motor power in response to the impact of the impact mechanism, detect a second impact of the impact mechanism, increment the count of the impact, compare the count of the impact to an impact threshold, control the motor at an intermediate motor power in response to the count of the impact being less than the impact threshold, the intermediate motor power being between the minimum motor power and the maximum motor power, and stop the motor in response to the count of the impact being greater than or equal to the impact threshold.

In some aspects, the electronic controller is further configured to detect an impact timing of the impact mechanism, determine whether the impact timing of the impact mechanism is within a predetermined range, and reduce the power provided to the motor in response to the impact timing of the impact mechanism being outside of the predetermined range.

In some aspects, the impact tool further includes one or more sensors configured to detect the first impact of the impact mechanism and output a signal to the electronic controller, wherein the one or more sensors of the impact mechanism include at least one selected from the group consisting of a hammer translation sensor, an anvil rotation sensor, or a current measurement sensor.

In some aspects, the maximum motor power is calculated by the electronic processor using at least one selected from the group consisting of a pulse-width modulation value, a revolutions per minute setpoint, a motor conduction angle, a motor phase angle, a quadrature axis direction current, or a direct axis direction current.

In some aspects, the minimum motor power is a preset power value stored in the memory and the maximum motor power is a calculated by the electronic processor.

In some aspects, the intermediate motor power is based upon an algorithm that includes the count of the impact of the impact mechanism.

In some aspects, the algorithm is at least one selected from the group consisting of a linear function, a stepwise linear function, and. a polynomial function.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,”

“an,” and “the” should not be interpreted as meaning “one” or “only one. ” Rather these articles should be interpreted as meaning “at least one” or “one or more. ” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of various embodiments will become apparent by consideration of the detailed description and accompanying drawings.

### BRIEF DESCRIPTION OF THE DRAWINGS

FIG. 1 illustrates an impact tool in accordance with embodiments described herein.

FIG. 2 is a schematic diagram of a controller of the impact tool of FIG. 1.

FIGS. 3A and 3B is an illustrate a hammer and an anvil of an impact mechanism of the impact tool of FIG. 1.

FIG. 4 is a flow chart of a process of controlling an impact tool in accordance with embodiments described herein.

FIG. 5 is a flow chart of a process of controlling an impact tool in accordance with embodiments described herein.

FIG. 6 is a graph of power of an impact tool in accordance with embodiments described herein.

FIG. 7 is a comparison of the predictability of impact events in accordance with embodiments described herein.

### DETAILED DESCRIPTION

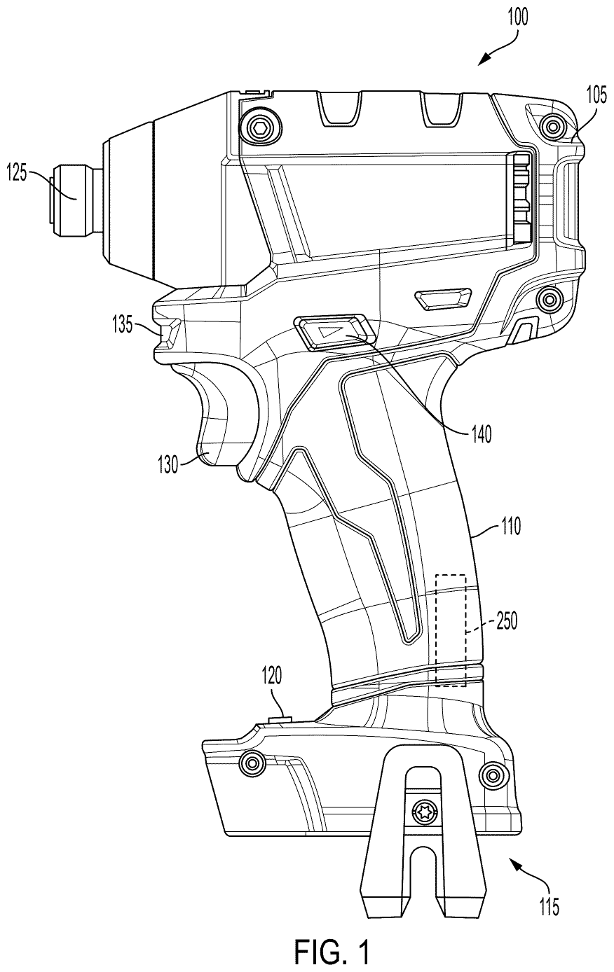

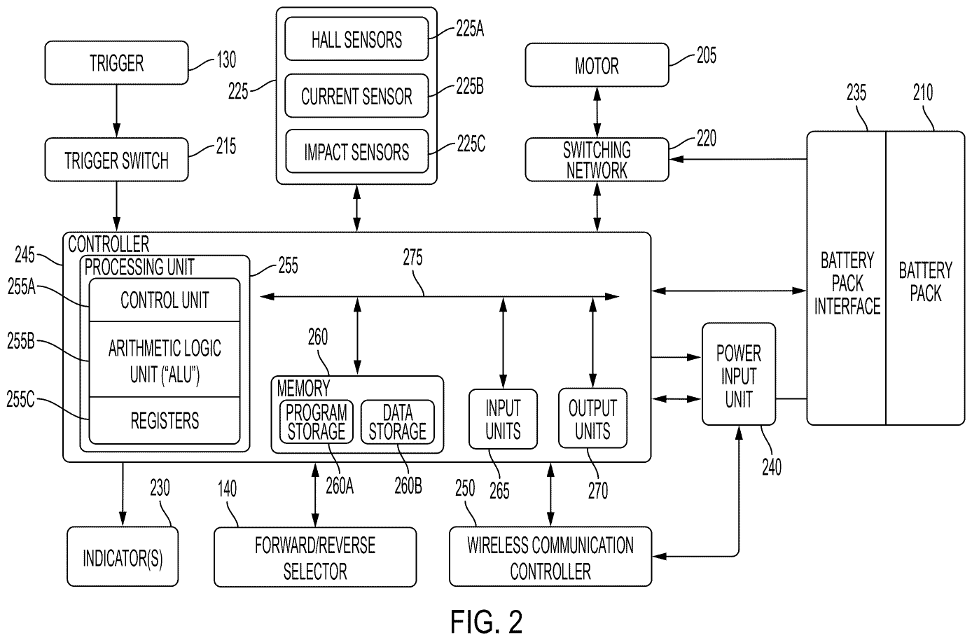

FIG. 1 illustrates a power tool 100, in particular an impact tool (e.g., an impact driver, an impact wrench, a hammer drill, etc.) associated with the task of generating a rotational output (e.g., to drive a bit). The impact tool 100 includes an upper main body 105, a handle 110, a battery pack receiving portion 115, a mode pad 120, an output drive device 125, a trigger 130, a work light 135, and a forward/reverse selector 140. The housing of the impact tool 100 (e.g., the main body 105 and the handle 110) are composed of, for example, a durable and light-weight plastic material or metal. The drive device 125 is composed of, for example, a metal (e.g., steel). In some embodiments, the drive device 125 on the impact tool 100 is a socket configured to receive a bit. The battery pack receiving portion 115 is configured to receive and couple to a battery pack (e.g., battery pack 210 of FIG. 2) that provides power to the impact tool 100. The battery pack receiving portion 115 includes a connecting structure to engage a mechanism that secures the battery pack and a terminal block to electrically connect the battery pack to the impact tool 100. The mode pad 120 allows a user to select a mode of the impact tool 100 and indicates to the user the currently selected mode of the impact tool 100, such as, for example, modes associated with differing torque levels or impact thresholds.

As shown in FIG. 2, the impact tool 100 also includes a motor 205. The motor 205 actuates the drive device 125 and provides the output torque to drive the bit. A primary power source or battery pack 210 couples to the impact tool 100 and provides electrical power to energize the motor 205. The motor 205 is energized based on the position of the trigger 130. When the trigger 130 is depressed, the motor 205 is energized, and when the trigger 130 is released, the motor 205 is de-energized. In the illustrated embodiment, the trigger 130 extends partially down a length of the handle 110. However, in other embodiments, the trigger 130 may be positioned elsewhere on the impact tool 100 or extend a different length down the handle. The trigger 130 is moveably coupled to the handle 110 such that the trigger 130 moves with respect to the tool housing. The trigger 130 moves in a first direction towards the handle 110 when the trigger 130 is depressed by the user. The trigger 130 is biased (e.g., with a spring) such that the trigger 130 moves in a second direction away from the handle 110 when the trigger 130 is released by the user. In some embodiments, when the trigger 130 is depressed by the user, a push rod activates the trigger switch 215, and when the trigger 130 is released by the user, the trigger switch 215 is deactivated. In other embodiments, the trigger 130 is coupled to an electrical trigger switch 215. In such embodiments, the trigger switch 215 may include, for example, a transistor. Additionally, for such electronic embodiments, the trigger 130 may not include a push rod to activate the mechanical switch. Rather, the electrical trigger switch 215 may be activated by, for example, a position sensor (e.g., a Hall-Effect sensor) that provides information about the relative position of the trigger 130.

The trigger switch 215 outputs a signal indicative of the position of the trigger 130. In some instances, the signal is binary and indicates either that the trigger 130 is depressed or released. In other instances, the signal indicates the position of the trigger 130 with more precision. For example, the trigger switch 215 may output an analog signal that various from 0 to 5 volts depending on the extent that the trigger 130 is depressed. For example, 0 V output indicates that the trigger 130 is released, 1 V output indicates that the trigger 130 is 20% depressed, 2 V output indicates that the trigger 130 is 40% depressed, 3 V output indicates that the trigger 130 is 60% depressed 4 V output indicates that the trigger 130 is 80% depressed, and 5 V indicates that the trigger 130 is 100% depressed. Put another way, the amount of pull provided by the user on the trigger 130 can determine the amount of power provided at the output of the motor 205. The signal output by the trigger switch 215 may be analog or digital.

As also shown in FIG. 2, the impact tool 100 includes a switching network 220, sensors 225, indicators 230, a battery pack interface 235, a power input unit 240, a controller 245, and a wireless communication controller 250. The battery pack interface 235 is connected to the controller 245 and couples to the battery pack 210. The battery pack interface 235 includes a combination of mechanical (e.g., the battery pack receiving portion 115) and electrical components configured to and operable for interfacing (e.g., mechanically, electrically, and communicatively connecting) the impact tool 100 with the battery pack 210. The battery pack interface 235 is coupled to the power input unit 240. The battery pack interface 235 transmits the power received from the battery pack 210 to the power input unit 240. The power input unit 240 includes active and/or passive components (e.g., voltage step-down controllers, voltage converters, rectifiers, filters, etc.) to regulate or control the power received through the battery pack interface 235 and to the wireless communication controller 250 and controller 245.

The switching network 220 enables the controller 245 to control the operation of the motor 205. When the trigger 130 is depressed as indicated by an output of the trigger switch 215, electrical current is supplied from the battery pack interface 235 to the motor 205, via the switching network 220. When the trigger 130 is not depressed, electrical current is not supplied from the battery pack interface 235 to the motor 205. In response to the controller 245 receiving the activation signal from the trigger switch 215, the controller 245 activates the switching network 220 to provide power to the motor 205. The switching network 220 controls the amount of current available to the motor 205 and thereby controls the speed, torque, and power output of the motor 205. The switching network 220 may include a plurality of switches, such as, for example, field-effect transistors (“FETs”, bipolar junction transistors, or other types of electrical switches. For instance, the switching network 220 may include a six-FET bridge that receives pulse-width modulated (PWM) signals from the controller 245 (or another gate driver) to drive the motor 205.

The sensors 225 are coupled to the controller 245 and communicate to the controller 245 various signals indicative of different parameters of the impact tool 100 and/or the motor 205. The sensors 225 include Hall effect sensors 225A, current sensors 225B, impact sensors 225C, among other sensors, such as, for example, one or more voltage sensors, one or more temperature sensors, and one or more torque sensors. Each Hall effect sensor 225A outputs motor feedback information to the controller 245, such as an indication (e.g., a pulse) when a magnet of the motor's rotor rotates across the face of that Hall effect sensor. Based on the motor feedback information from the Hall effect sensors 225A, the controller 245 can determine the position, velocity, and/or acceleration of the rotor. The electronic processor 255 may detect that the impact tool 100 is in operation based on depression of the trigger 130 or output signals from Hall effect sensors indicating that the motor 205 is rotating. The electronic processor 255 may also detect impact events using the impact sensors 225C. The impact sensors 225C can include a hammer translation sensor, an anvil rotation sensor, a current measurement (e.g., battery current, motor current, or the like), oscillation patterns of the impact tool 100 as measured by a sensor, etc. In some embodiments, the impact sensors include one or more inductive sensors, one or more Hall effect sensors, etc. In some embodiments, impact events can be detected using threshold parameters, machine learning algorithms, or 1-dimensional Kalman filters.

In response to the motor feedback information and the signals from the trigger switch 215, the controller 245 transmits control signals to control the switching network 220 to drive the motor 205. For instance, by selectively enabling and disabling the FETs of the switching network 220, power received via the battery pack interface 235 is selectively applied to stator coils of the motor 205 to cause rotation of its rotor. The controller 245 uses the motor feedback information to ensure proper timing of control signals to the switching network 220 and, in some instances, to provide closed-loop feedback to control the speed of the motor 205 to be at a desired level.

The indicators 230 are also coupled to the controller 245 and receive control signals from the controller 245 to turn on and off or otherwise convey information based on different states of the impact tool 100. The indicators 230 include, for example, one or more light-emitting diodes (“LED”), or a display screen. The indicators 230 can be configured to display conditions of, or information associated with, the impact tool 100. For example, the indicators 230 are configured to indicate measured electrical characteristics of the impact tool 100, the status of the impact tool 100, the mode of the power tool, etc. The indicators 230 may also include elements to convey information to a user through audible or tactile outputs.

As described above, the controller 245 is electrically and/or communicatively connected to a variety of modules or components of the impact tool 100. In some embodiments, the controller 245 includes a plurality of electrical and electronic components that provide power, operational control, and protection to the components and modules within the controller 245 and/or impact tool 100. For example, the controller 245 includes, among other things, a processing unit 255 (e.g., a microprocessor, a microcontroller, an electronic controller, an electronic processor, or another suitable programmable device), a memory 260, input units 265, and output units 270. The processing unit 255 (herein, electronic processor 255) includes, among other things, a control unit 255A, an arithmetic logic unit (“ALU”) 255B, and a plurality of registers 255C (shown as a group of registers in FIG. 2). In some embodiments, the controller 245 is implemented partially or entirely on a semiconductor (e.g., a field-programmable gate array [“FPGA”] semiconductor) chip, such as a chip developed through a register transfer level (“RTL”) design process. The electronic processor 255, the memory 260, and the input units 265 and output units 270 are electronically and communicatively connected to each other via one or more busses, such as common bus 275.

The memory 260 is a non-transitory computer readable medium and includes, for example, a program storage area 260A and a data storage area 260B. The program storage area 260A and the data storage area 260B can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The electronic processor 255 is connected to the memory 260 and executes software instructions that are capable of being stored in a RAM of the memory 260 (e.g., during execution), a ROM of the memory 260 (e.g., on a generally permanent basis), or another non-transitory computer readable medium such as another memory or a disc. Software included in the implementation of the impact tool 100 can be stored in the memory 260 of the controller 245. The software includes, for example, firmware, one or more applications, program data, filters, rules, one or more program modules, and other executable instructions.

The controller 245 is configured to retrieve from memory and execute, among other things, instructions related to the control processes and methods described herein. The controller 245 is also configured to store power tool information on the memory 260 including operational data, information identifying the type of tool, a unique identifier for the particular tool, and other information relevant to operating or maintaining the impact tool 100. The tool usage information, such as current levels, motor speed, motor acceleration, motor direction, number of impacts, may be captured or inferred from data output by the sensors 225. Such power tool information may then be accessed by a user with an external device. In other constructions, the controller 245 includes additional, fewer, or different components.

The wireless communication controller 250 is coupled to the controller 245 and includes a radio transceiver and antenna, and in some embodiments may include a memory, an electronic processor, and input/output elements similar but independent from those previously described with respect to the controller 245. The radio transceiver and antenna operate together to send and receive wireless messages to and from the external device. In some embodiments, the wireless communication controller 250 is a Bluetooth® controller. In other embodiments, the wireless communication controller 250 communicates using other protocols (e.g., Wi-Fi, cellular protocols, a proprietary protocol, etc.) over a different type of wireless network. For example, the wireless communication controller 250 may be configured to communicate via Wi-Fi through a wide area network such as the Internet or a local area network, or to communicate through a piconet (e.g., using infrared or NFC communications). The communication via the wireless communication controller 250 may be encrypted to protect the data exchanged between the impact tool 100 and an external device/network from third parties.

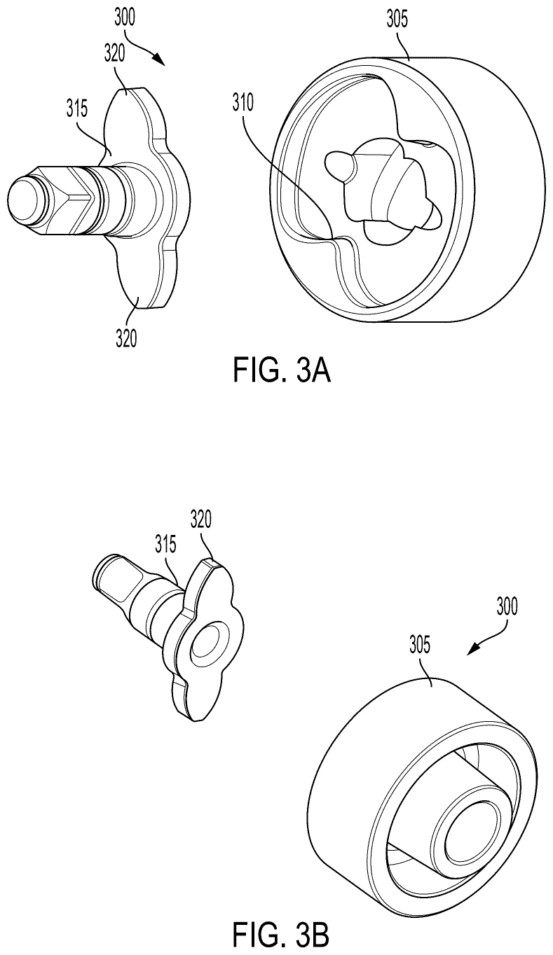

FIGS. 3A and 3B show an impact mechanism 300, which is an example of an impact mechanism of the impact tool 100. Based on the design of the impact mechanism 300 of the impact tool 100, the motor 205 rotates at least a number of degrees between impacts (i.e., 180 degrees for the impact mechanism 300). The impact mechanism 300 includes a hammer 305 with outwardly extending lugs 310 and an anvil 315 with outwardly extending lugs 320. The anvil 315 is coupled to the output drive device 125. During operation, impacting occurs when the anvil 315 encounters a certain amount of resistance (e.g., when driving a fastener into a workpiece). When this resistance is met, the hammer 305 continues to rotate. A spring coupled to the backside of the hammer 305 causes the hammer 305 to disengage the anvil 315 by axially retreating. Once disengaged, the hammer 305 will advance both axially and rotationally to again engage (i.e., impact) the anvil 315. When the impact mechanism 300 is operated, the hammer lugs 310 impact the anvil lugs 320 every, for example, 180 degrees. Accordingly, when the impact tool 100 is impacting, the hammer 305 rotates without the anvil 315, impacts the anvil 315, and then rotates with the anvil 315 a certain amount before repeating the process.

The controller 245 can determine how far the hammer 305 and the anvil 315 rotated together by monitoring the angle of rotation of the shaft of the motor 205 between impacts. For example, when the impact tool 100 is driving an anchor into a softer joint, the hammer 305 may rotate 225 degrees in between impacts. In this example of 225 degrees, 45 degrees of the rotation includes hammer 305 and anvil 315 engaged with each other and 180 degrees includes just the hammer 305 rotating before the hammer lugs 310 impact the anvil 315 again. The controller 245 also monitors for the start of impact operations and the torque-per-impact provided during operation to control the motor. This process is described in greater detail below.

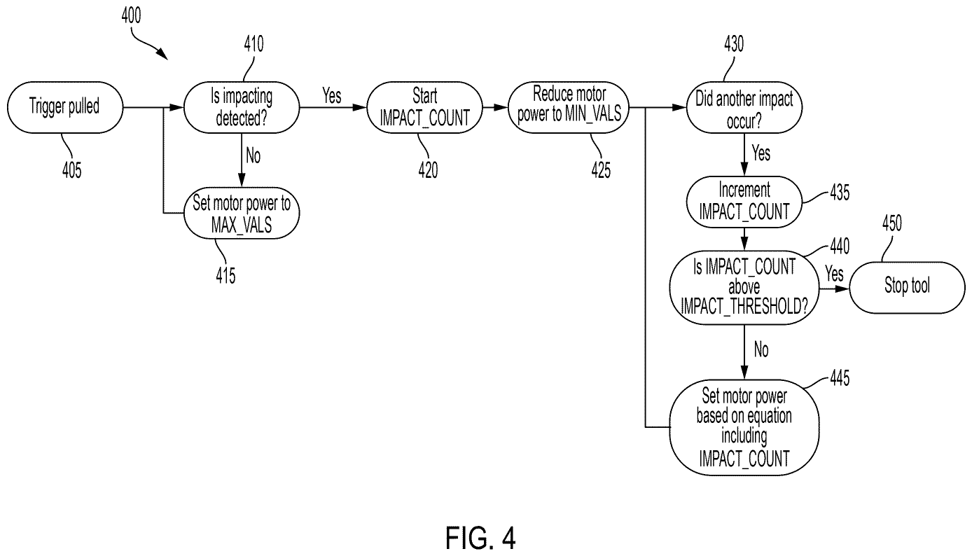

FIG. 4 is a flowchart of a process 400 to control the impact tool 100. The process 400 begins at step 405 with the pull of the trigger 130, as previously described. The motor 205 then runs at full speed (e.g., while driving in a fastener with minimal resistance). When an impact is not detected (step 410), the controller 245 provides the maximum available power to the motor 205 (step 415). In some embodiments, the maximum amount of power is a value stored in the memory 260 (e.g., MAX_VALS). The maximum power may also be calculated by the electronic processor 255 using parameters of the impact tool 100, such as a pulse-width modulation value (e.g., duty cycle percentage) of the motor 205, an RPM (revolutions per minute) setpoint of the motor 205, a motor conduction angle, a motor phase angle, a quadrature axis direction current (e.g., Iq), a direct axis direction current (e.g., Id), or any combination thereof. Once an impact of the impact mechanism 300 is detected at step 415, the controller 245 begins a count of the impacts of the impact mechanism 300 (step 420) and reduces the power provided to the motor 205 to a predetermined threshold value (step 425). The predetermined threshold may be, for example, a minimum amount of motor power to rotate the motor 205 (e.g., MIN_VALS). The minimum power may also be calculated by the electronic processor 255 using parameters similar to those of the minimum power. In some embodiments, the minimum amount of power is a value stored in the memory 260. The controller 245 may reduce power to the motor by lowering the PWM signal duty cycle or through the use of closed loop speed control target set points.

For each detected impact of the impact mechanism 300, the controller 245 increases the amount of power provided to the motor 205. This increase may be a linear increase in power or a non-linear increase in power. For a linear increase in power, the controller 245 may increase motor power by a fixed amount per impact. For example, after an impact event, the controller 245 may increase motor power provided by the motor 205 by 1%, 2%, 5%, or the like. For a non-linear increase in power, motor power may be increased based upon an equation or algorithm (e.g., a polynomial equation, an exponential function, a logarithmic function, etc. For example, the electronic processor 255 may calculate motor power based upon the total number of impacts detected, by current/voltage measurements of the motor 205 as detected by the sensors 225, an RPM value of the motor 205, a run time of the motor 205, or any combination thereof. The controller 245 may increase power to the motor by increasing the PWM signal duty cycle, increasing the closed loop speed control target, increasing motor field weakening parameters, or by increasing field-oriented control parameters. In some embodiments, power is increased every two impacts or every three or more impacts. In some embodiments, power is increased for each even count of the impacts (e.g., every other impact). In other embodiments, power is increased for each odd count of the impacts.

The controller 245 then continues driving the motor 205 (step 430). The count of the impacts is stored in the memory 260 and incremented for each detected impact at step 435 (e.g., IMPACT_COUNT). The controller 245 then compares the count of the impacts to a predetermine threshold value (e.g., IMPACT_THRESHOLD) at step 440. When the count of the impacts is below the threshold value, the controller 245 sets and increments the motor power at step 445 before returning to monitoring for impacts (at step 430). In some embodiments, the count of the impacts is included in the motor power determination. When the count of the impacts is equal to or greater than the threshold value, the controller 245 stops the motor 205 and ends operation of the impact tool 100 (step 450).

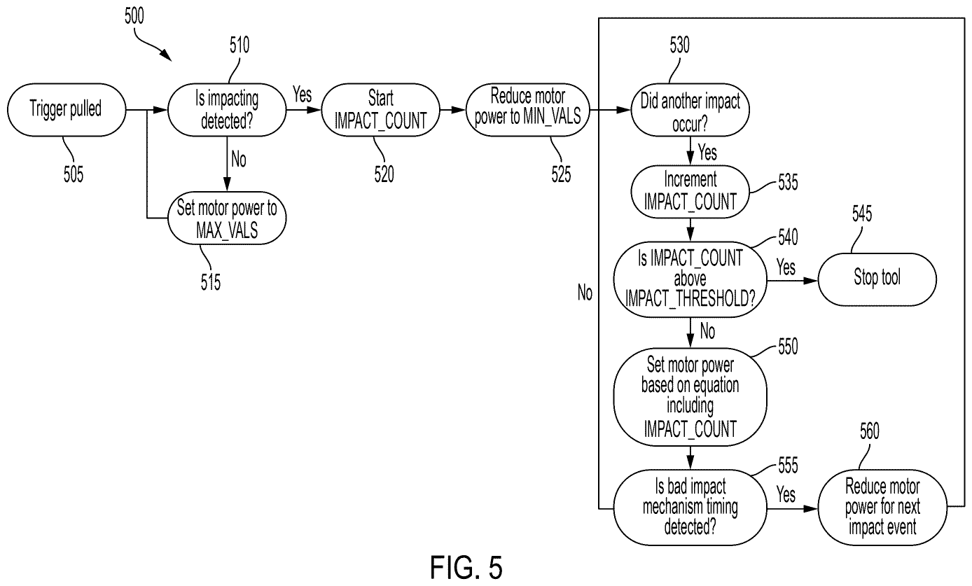

FIG. 5 is a flowchart of a process 500 to control the impact tool 100 similar to the process 400 described with respect to FIG. 4. The process 500 begins at step 505 with the pull of the trigger 130, as previously described. The motor 205 runs at full speed, and when an impact is not detected (step 510), the controller 245 provides the maximum available power to the motor 205 (step 515). Similar to process 400, the maximum amount of power is a value stored in the memory 260 (e.g., MAX_VALS). The maximum power may also similarly be calculated by the electronic processor 255 using parameters of the impact tool 100, such as a pulse-width modulation value (e.g., duty cycle percentage) of the motor 205, an RPM setpoint of the motor 205, a motor conduction angle, a motor phase angle, a quadrature axis direction current (e.g., Iq), a direct axis direction current (e.g., Id), or any combination thereof. Once an impact of the impact mechanism 300 is detected at step 510, the controller 245 begins a count of the impacts of the impact mechanism 300 (step 520) and reduces the power provided to the motor 205 to a predetermined threshold value (step 525). Similar to process 400, the predetermined threshold may be, for example, a minimum amount of motor power to rotate the motor 205 (e.g., MIN_VALS). The minimum power may also be calculated by the electronic processor 255 using parameters similar to those of the minimum power. In some embodiments, the minimum amount of power is a value stored in the memory 260.

For each detected impact of the impact mechanism 300, the controller 245 increases the amount of power provided to the motor 205. As described with respect to process 400, the increase may be a linear increase in power or a non-linear increase in power. The controller 245 then continues driving the motor 205 (step 525) and monitoring for additional impacts of the impact mechanism 300 (step 530). The count of the impacts is stored in the memory 260 and is incremented (at step 535) for each detected impact (e.g., IMPACT_COUNT). The controller 245 then compares the count of the impacts to a predetermine threshold value (e.g., IMPACT_THRESHOLD) at step 540. When the count of the impacts is equal to or greater than the predetermine threshold, the controller 245 stops the motor 205 and ends operation of the impact tool 100 (step 545). On the other hand, when the count of the impacts is below the predetermine threshold, the controller 245 sets the motor power (at step 550) to a power level between the minimum and maximum motor power levels based upon an equation (e.g., a linear function, a step-wise linear function, a polynomial function, etc.) that includes the total count of impacts (e.g., the value saved as IMPACT_COUNT). In some embodiments, this power level is referred to as an intermediate motor power.

The controller 245 also monitors the impact timing of the impact mechanism 300. For example, the impact timing of the impact mechanism 300 may be defined as “normal” or “abnormal” based upon when the hammer 305 delivers force to the anvil 315. A normal impact timing may be determined by the controller 245 based upon a setpoint (as selected by the mode pad 120) or based upon a predetermined range. For example, when impact timing occurs outside of a predetermined range, the controller 245 may determine that impact timing is abnormal. The controller may also determine an abnormal timing when impact events do not match a predetermined pattern that corresponds with motor RPM. When the controller 245 determines that the impact timing is normal, at step 555, the process returns to step 530 where controller 245 continues to monitor for impacts of the impact mechanism 300. On the other hand, when the controller 245 determines (step 555) that the impact timing is not normal (e.g., a bad impact has occurred, hammer crashing, hammer position exceeds a maximum threshold, abnormal motor speed pattern, etc.), the controller reduces the motor power for the next impact event (step 560). The reduction in motor power may be a linear reduction in power or a non-linear reduction in power, similar to the increase in motor power previously described with respect to the process 400, 500.

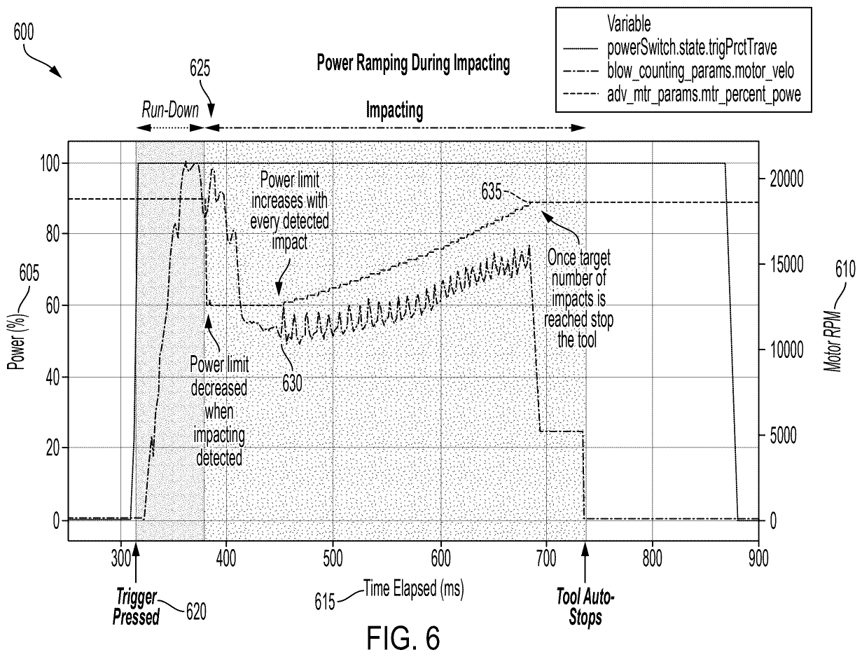

FIG. 6 is a graph 600 of power provided while the impact tool 100 is operating using the process 400, 500. The graph 600 illustrates the amount of power 605 (shown in total percentage) output by the motor 205 and the motor speed (e.g., RPM) 610 (e.g., of the motor 205) over time 615. As previously described, when the trigger 130 is pressed (e.g., at 620 on graph 600), power is provided to the motor 205. When impacting is detected (e.g., at 625 on graph 600), such as at step 415 of process 400 or step 515 of process 500, the motor power is reduced to a minimum value. As previously described, the minimum value may be a preset value, such as 60% of motor power, or based on a speed setpoint for the motor, such as 12,500 RPM. As impacts are detected during operation (e.g., at 630 on the graph 600), the count of the impacts is incremented and the motor power output is increased, as previously described. Once the target count of the impacts has been reached (e.g., at 635 on the graph 600), the controller 245 stops the motor 205 and ends operation of the impact tool 100.

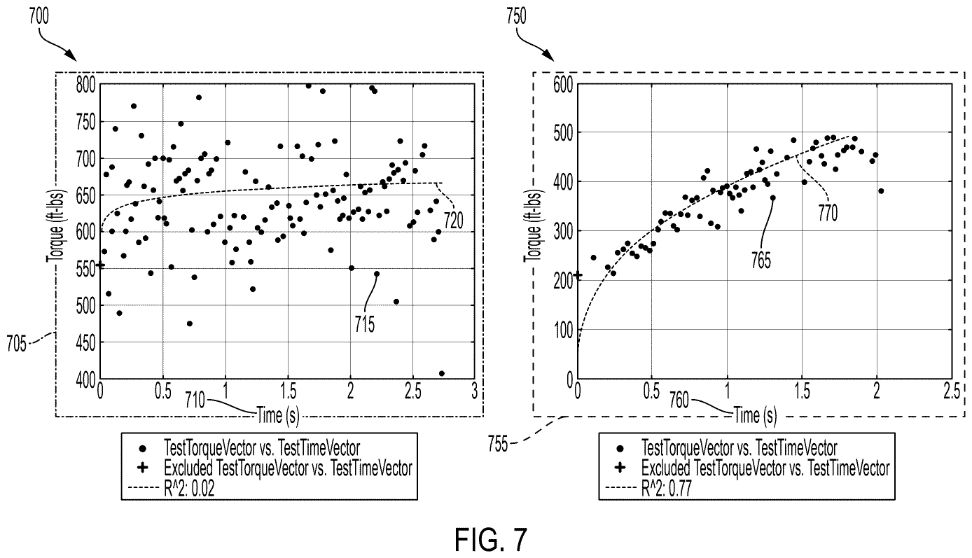

FIG. 7 is a graphical illustration of the comparison between impact events using the process 400, 500 and impacts not using the process 400, 500. FIG. 7 includes a graph 700 of torque per impact events using standard processes and a graph 750 of torque per impact events using the process 400, 500, as previously described. The graph 700 includes a Y-axis 705 of torque in foot-pounds (lb) and an X-axis 710 of time in seconds(s). Impacts 715 recorded as the impact tool 100 operates are illustrated, with an average impact curve 720 of all impacts 715 over time. As illustrated, the average impact curve 720 starts at approximately 600 ft-lb of torque at 0 seconds and increases to approximately 660 ft-lb of torque at 2.5 seconds.

In contrast to the graph 700 using standard processes, the graph 750 illustrates the torque per impact events using the process 400, 500. The graph 750 includes similar axis, a Y-axis 755 of torque in foot-pounds (ft-lb) and an X-axis 760 of time in seconds(s). Also illustrated are impacts 765 of the impact tool 100 and an average impact curve 770 of all impacts 765 over time. As illustrated, the average impact curve 770 starts at approximately 0 ft-lb of torque at 0 seconds and increases to approximately 500 ft-lb of torque at 1.7 seconds. Notably, the torque-per-impact using the process 400, 500 as shown in the graph 750 is demonstrably less variable than without using the process 400, 500. As demonstrated by the comparison, a highly accurate control of the impact tool 100 is obtained by counting the impacts and increasing power as performed in the processes 400, 500 previously described. The motor power ramping allows the impact tool 100 to make each torque output more predictable (e.g., closer to average) and efficient, offering an improved and enhanced experience.

The following are examples of the present disclosure described herein. It should be understood that any of the examples may be combined to include some or all of the features of any other example. Likewise, any of the features of the illustrations as described herein may be included in any combination with any of the examples.

Example 1. An impact tool comprising: a housing; a trigger; a motor within the housing, the motor including a rotor and a stator, the rotor coupled to a motor shaft; an impact mechanism including a hammer coupled to the motor shaft and an anvil configured to receive impacts from the hammer; an output drive device coupled to the anvil and configured to rotate; and an electronic controller including a memory and an electronic processor, the electronic controller configured to: detect a pull of the trigger, control the motor at a first motor power in response to the pull of the trigger, detect a first impact of the impact mechanism, store a count of the impact of the impact mechanism in the memory, control the motor at a second motor power in response to the impact of the impact mechanism; detect a second impact of the impact mechanism, increment the count of the impact; compare the count of the impact to an impact threshold, control the motor at a third motor power in response to the count of the impact being less than the impact threshold, the third motor power being greater than the second motor power; and stop the motor in response to the count of the impact being greater than or equal to the impact threshold.

Example 2. The impact tool of example 1, wherein the first motor power is a maximum motor power, and the second motor power is a minimum motor power.

Example 3. The impact tool of any of examples 1-2, wherein at least one of the first motor power, the second motor power and the third motor power are determined by the electronic processor using at least one selected from the group consisting of a pulse-width modulation value, a revolutions per minute setpoint, a motor conduction angle, and a motor phase angle.

Example 4. The impact tool of any of examples 1-3, wherein the electronic controller controls the motor at the second motor power by lowering a pulse-width modulation signal duty cycle.

Example 5. The impact tool of any of examples 1-4, wherein the electronic controller controls the motor at the second motor power using one or more closed-loop speed control target set points.

Example 6. The impact tool of any of examples 1-5, the electronic processor further configured to control the motor at the third motor power in response to the count of the impact being incremented by two.

Example 7. The impact tool of any of examples 1-6, wherein the third motor power is greater than the second motor power by a predetermined value.

Example 8. The impact tool of any of examples 1-7, wherein the third motor power is calculated by the electronic processor using an algorithm.

Example 9. The impact tool of example 8, wherein the algorithm includes at least one selected from the group consisting of a total number of impacts detected by the electronic processor, a current measurement of the motor, a voltage measurement of the motor, a revolutions per minute value of the motor, and a run time of the motor.

Example 10. A method of controlling an impact tool including a housing, a trigger, a motor within the housing, an impact mechanism including a hammer and an anvil configured to receive impacts from the hammer, and an electronic controller including a memory and an electronic processor, the method comprising: detecting, using the electronic processor, a pull of the trigger; controlling, using the electronic processor, the motor at a first motor power in response to the pull of the trigger; detecting, using the electronic processor, a first impact of the impact mechanism; storing, in the memory, a count of the impact of the impact mechanism; controlling, using the electronic processor, the motor at a second motor power in response to the impact of the impact mechanism; detecting, using the electronic processor, a second impact of the impact mechanism; incrementing, using the electronic processor, the count of the impact; comparing, using the electronic processor, the count of the impact to an impact threshold; controlling, using the electronic processor, the motor at a third motor power in response to the count of the impact being less than the impact threshold, the third motor power being greater than the second motor power; and stopping, using the electronic processor, the motor in response to the count of the impact being greater than or equal to the impact threshold.

Example 11. The method of example 10, wherein at least one of the first motor power, the second motor power and the third motor power are determined by the electronic processor using at least one selected from the group consisting of a pulse-width modulation value, a revolutions per minute setpoint, a motor conduction angle, and a motor phase angle.

Example 12. The method of any of examples 10-11, the method further comprising: detecting, using the electronic processor, an impact timing of the impact mechanism; determining, using the electronic processor, whether the impact timing of the impact mechanism is within a predetermined range; and reducing, using the electronic processor, the power provided to the motor in response to the impact timing of the impact mechanism being outside of the predetermined range.

Example 13. The method of any of examples 10-12, the method further comprising: calculating, using the electronic processor, a motor power value for the third motor power, increasing, using the electronic processor, the motor power value in response incrementing the count of the impact, and controlling, using the electronic processor, the motor at a third motor power.

Example 14. The method of claim 13, wherein the electronic processor increases the motor power value by a predetermined amount after every two increments of the count of the impact.

Example 15. An impact tool comprising: a housing; a trigger; a motor within the housing, the motor including a rotor and a stator, the rotor is coupled to a motor shaft; an impact mechanism including a hammer coupled to the motor shaft and an anvil configured to receive impacts from the hammer; an output drive device coupled to the anvil and configured to rotate; and an electronic controller including a memory and an electronic processor, the electronic controller configured to: detect a pull of the trigger, control the motor at a maximum motor power in response to the pull of the trigger, detect a first impact of the impact mechanism, store a count of the impact of the impact mechanism in the memory, control the motor at a minimum motor power in response to the impact of the impact mechanism, detect a second impact of the impact mechanism, increment the count of the impact, compare the count of the impact to an impact threshold, control the motor at an intermediate motor power in response to the count of the impact being less than the impact threshold, the intermediate motor power being between the minimum motor power and the maximum motor power, and stop the motor in response to the count of the impact being greater than or equal to the impact threshold.

Example 16. The impact tool of example 15, wherein the electronic controller is further configured to: detect an impact timing of the impact mechanism; determine whether the impact timing of the impact mechanism is within a predetermined range; and reduce the power provided to the motor in response to the impact timing of the impact mechanism being outside of the predetermined range.

Example 17. The impact tool of any of examples 15-16, further comprising: one or more sensors configured to detect the first impact of the impact mechanism and output a signal to the electronic controller, wherein the one or more sensors of the impact mechanism include at least one selected from the group consisting of a hammer translation sensor, an anvil rotation sensor, or a current measurement sensor.

Example 18. The impact tool of any of examples 15-17, wherein the maximum motor power is calculated by the electronic processor using at least one selected from the group consisting of a pulse-width modulation value, a revolutions per minute setpoint, a motor conduction angle, a motor phase angle, a quadrature axis direction current, or a direct axis direction current.

Example 19. The impact tool of any of examples 15-18, wherein the minimum motor power is a preset power value stored in the memory and the maximum motor power is a calculated by the electronic processor.

Example 20. The impact tool of any of examples 15-19, wherein the intermediate motor power is based upon an algorithm that includes the count of the impact of the impact mechanism.

Thus, embodiments described herein provide, among other things, systems, and methods for controlling power tools with impact mechanisms. Various features and advantages of the invention are set forth in the following claims.

We claim:

1. An impact tool comprising:
a housing;
a trigger;
a motor within the housing, the motor including a rotor and a stator, the rotor coupled to a motor shaft;
an impact mechanism including a hammer coupled to the motor shaft and an anvil configured to receive impacts from the hammer;
an output drive device coupled to the anvil and configured to rotate; and
an electronic controller including a memory and an electronic processor, the electronic controller configured to:
detect a pull of the trigger,
control the motor at a first motor power in response to the pull of the trigger,
detect a first impact of the impact mechanism,
store a count of the impact of the impact mechanism in the memory,
control the motor at a second motor power in response to the impact of the impact mechanism;
detect a second impact of the impact mechanism,
increment the count of the impact;
compare the count of the impact to an impact threshold,
control the motor at a third motor power in response to the count of the impact being less than the impact threshold, the third motor power being greater than the second motor power; and
stop the motor in response to the count of the impact being greater than or equal to the impact threshold.

2. The impact tool of claim 1, wherein the first motor power is a maximum motor power, and the second motor power is a minimum motor power.

3. The impact tool of claim 1, wherein at least one of the first motor power, the second motor power and the third motor power are determined by the electronic processor using at least one selected from the group consisting of a pulse-width modulation value, a revolutions per minute setpoint, a motor conduction angle, and a motor phase angle.

4. The impact tool of claim 1, wherein the electronic controller is configured to control the motor at the second motor power by lowering a pulse-width modulation signal duty cycle.

5. The impact tool of claim 1, wherein the electronic controller is configured to control the motor at the second motor power using one or more closed-loop speed control target set points.

6. The impact tool of claim 1, the electronic processor further configured to control the motor at the third motor power in response to the count of the impact being incremented by two.

7. The impact tool of claim 1, wherein the third motor power is greater than the second motor power by a predetermined value.

8. The impact tool of claim 1, wherein the third motor power is calculated by the electronic processor using an algorithm.

9. The impact tool of claim 8, wherein the algorithm includes at least one selected from the group consisting of a total number of impacts detected by the electronic processor, a current measurement of the motor, a voltage measurement of the motor, a revolutions per minute value of the motor, and a run time of the motor.

10. A method of controlling an impact tool including a housing, a trigger, a motor within the housing, an impact mechanism including a hammer and an anvil configured to receive impacts from the hammer, and an electronic controller including a memory and an electronic processor, the method comprising:
detecting, using the electronic processor, a pull of the trigger;
controlling, using the electronic processor, the motor at a first motor power in response to the pull of the trigger;
detecting, using the electronic processor, a first impact of the impact mechanism;
storing, in the memory, a count of the impact of the impact mechanism;
controlling, using the electronic processor, the motor at a second motor power in response to the impact of the impact mechanism;
detecting, using the electronic processor, a second impact of the impact mechanism;
incrementing, using the electronic processor, the count of the impact;
comparing, using the electronic processor, the count of the impact to an impact threshold;
controlling, using the electronic processor, the motor at a third motor power in response to the count of the impact being less than the impact threshold, the third motor power being greater than the second motor power; and
stopping, using the electronic processor, the motor in response to the count of the impact being greater than or equal to the impact threshold.

11. The method of claim 10, wherein at least one of the first motor power, the second motor power and the third motor power are determined by the electronic processor using at least one selected from the group consisting of a pulse-width modulation value, a revolutions per minute setpoint, a motor conduction angle, and a motor phase angle.

12. The method of claim 10, further comprising:
detecting, using the electronic processor, an impact timing of the impact mechanism;
determining, using the electronic processor, whether the impact timing of the impact mechanism is within a predetermined range; and
reducing, using the electronic processor, the power provided to the motor in response to the impact timing of the impact mechanism being outside of the predetermined range.

13. The method of claim 10, further comprising:
calculating, using the electronic processor, a motor power value for the third motor power,
increasing, using the electronic processor, the motor power value in response incrementing the count of the impact, and
controlling, using the electronic processor, the motor at a third motor power.

14. The method of claim 13, wherein the electronic processor increases the motor power value by a predetermined amount after every two increments of the count of the impact.

15. An impact tool comprising:
a housing;
a trigger;
a motor within the housing, the motor including a rotor and a stator, the rotor is coupled to a motor shaft;
an impact mechanism including a hammer coupled to the motor shaft and an anvil configured to receive impacts from the hammer;
an output drive device coupled to the anvil and configured to rotate; and
an electronic controller including a memory and an electronic processor, the electronic controller configured to:
detect a pull of the trigger,
control the motor at a maximum motor power in response to the pull of the trigger,
detect a first impact of the impact mechanism,
store a count of the impact of the impact mechanism in the memory,
control the motor at a minimum motor power in response to the impact of the impact mechanism,
detect a second impact of the impact mechanism,
increment the count of the impact,
compare the count of the impact to an impact threshold,
control the motor at an intermediate motor power in response to the count of the impact being less than the impact threshold, the intermediate motor power being between the minimum motor power and the maximum motor power, and
stop the motor in response to the count of the impact being greater than or equal to the impact threshold.

16. The impact tool of claim 15, wherein the electronic controller is further configured to:
detect an impact timing of the impact mechanism;
determine whether the impact timing of the impact mechanism is within a predetermined range; and
reduce the power provided to the motor in response to the impact timing of the impact mechanism being outside of the predetermined range.

17. The impact tool of claim 15, further comprising:
one or more sensors configured to detect the first impact of the impact mechanism and output a signal to the electronic controller,
wherein the one or more sensors of the impact mechanism include at least one selected from the group consisting of a hammer translation sensor, an anvil rotation sensor, or a current measurement sensor.

18. The impact tool of claim 15, wherein the maximum motor power is calculated by the electronic processor using at least one selected from the group consisting of a pulse-width modulation value, a revolutions per minute setpoint, a motor conduction angle, a motor phase angle, a quadrature axis direction current, or a direct axis direction current.

19. The impact tool of claim 15, wherein the minimum motor power is a preset power value stored in the memory and the maximum motor power is a calculated by the electronic processor.

20. The impact tool of claim 15, wherein the intermediate motor power is based upon an algorithm that includes the count of the impact of the impact mechanism.
